(19) United States
(12) Patent Application Publication
(10) Pub. No.: US 2022/0341324 A1
(43) Pub. Date: Oct. 27, 2022

(54) Rubber Applicator Device for Concrete Joint Lines

(71) Applicant: Nettie Jackson, Baton Rouge, LA (US)

(72) Inventor: Nettie Jackson, Baton Rouge, LA (US)

(21) Appl. No.: 17/729,059

(22) Filed: Apr. 26, 2022

Related U.S. Application Data
(60) Provisional application No. 63/180,158, filed on Apr. 27, 2021.

(51) Int. Cl. E21D 11/38

(52) U.S. Cl. CPC E21D 11/381

(57) ABSTRACT

The present invention relates generally to a rubber applicator device for concrete joint lines that is primarily comprised of a body further comprised of an exterior shaft, an interior shaft, a rotating locking mechanism, and at least one protrusion. The body of the device is preferably cylindrical and can increase in length to accommodate users of any height. The at least one protrusion guides rubber into a concrete keyway, while the user walks the device along the concrete keyway. In this manner, the device can be applied to any concrete keyway joint, such that a user can remain upright with less stress and strain on their back, while applying rubber to a concrete keyway joint.

### CROSS-REFERENCE TO RELATED APPLICATION

The present application claims priority to, and the benefit of, U.S. Provisional Application No. 63/180,158, which was filed on Apr. 27, 2021, and is incorporated herein by reference in its entirety.

### FIELD OF THE INVENTION

The present invention relates generally to the field of concrete applicators. More specifically, the present invention relates to a rubber applicator device for concrete joint lines that is primarily comprised of a body further comprised of an exterior shaft, an interior shaft, a rotating locking mechanism, and at least one protrusion. The at least one protrusion guides rubber into a concrete keyway, while the user walks the device along the concrete keyway. In this manner, the device can be applied to any concrete keyway joint, such that a user can remain upright with less stress and strain on their back while applying rubber to a concrete keyway joint. Accordingly, the present disclosure makes specific reference thereto. Nonetheless, it is to be appreciated that aspects of the present invention are also equally applicable to other like applications, devices and methods of manufacture.

### BACKGROUND

Concrete can be used for many foundational and recreational purposes in both large construction projects and smaller scale renovations. However, laying the concrete can be an incredibly tedious and frustrating process, especially when the concrete must cover a large area. Typically, concrete must be laid in slabs, with rubber separating each slab in a keyway. Further, applying rubber to a concrete keyway can be incredibly frustrating and uncomfortable. Specifically, when applying the rubber, a user needs to bend down and manually place the rubber on the keyway, risking back aches and pains. The user then must continue to place the rubber in the keyway, while remaining in a bent position. This process is repeated many times over a large area, increasing the risk of injury.

Therefore, there exists a long-felt need in the art for a rubber applicator device for concrete joint lines. There also exists a long-felt need in the art for a device that allows a user to remain standing in an upright position, while simultaneously applying rubber to a concrete keyway. Further, there exists a long-felt need in the art for a rubber applicator device that can change in length to accommodate users of differing heights. In addition, there exists a long-felt need in the art for a rubber applicator device for concrete joint lines that increases the efficiency of applying rubber to a concrete keyway, such that the application is a less time-consuming process.

The subject matter disclosed and claimed herein, in one embodiment thereof, comprises a rubber applicator device for concrete joint lines. The device is primarily comprised of a body further comprised of an exterior shaft, an interior shaft, a rotating locking mechanism, and at least one protrusion. The body of the device is preferably cylindrical in shape and may increase in length to accommodate users of differing heights. The at least one protrusion guides the rubber into a concrete keyway, while the device is walked along the concrete keyway joint. In this manner, the device can be applied to any concrete keyway joint, such that a user can remain upright with less stress and strain on their back while applying rubber to the concrete keyway joint.

In this manner, the rubber applicator device for concrete joint lines of the present invention accomplishes all the forgoing objectives and provides a means to apply rubber to a concrete keyway without requiring the user to uncomfortably bend and hunch over. Further, the device can extend in length to accommodate users of different heights and keyways that may be difficult-to-reach due to restraints on a construction site. In addition, the device is efficient, such that it decreases the time required to apply rubber to a concrete keyway.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a rubber applicator device for concrete joint lines. The device is primarily comprised of a body further comprised of an exterior shaft, an interior shaft, a rotating locking mechanism, and at least one protrusion. In the preferred embodiment, the body resembles a cylindrical shape. The body may also be manufactured of a plurality of materials, including many differing kinds of metals. However, the body is preferably made of a flexible or semi-flexible plastic material. In addition, any surface of the body may be comprised of a plurality of indicia, such as patterns, logos, emblems, images, symbols, designs, letters, words, characters, animals, advertisements, brands, etc.

The body is also comprised of two shafts. An interior shaft slides inside of an exterior shaft and can move freely, allowing the device to increase in length. A rotating locking mechanism fixedly attached to the exterior shaft may temporarily secure the interior shaft at a distance extended outwards from the exterior shaft. By twisting the rotating locking mechanism in one direction, the rotating locking mechanism compresses the internal shaft, retaining the internal shaft in place and not allowing it to move. To decompress the rotating locking mechanism, the rotating locking mechanism is twisted in the opposite direction, releasing the internal shaft and allowing it to move freely, which increases or decreases the length of the device.

The body also has two ends. A first end may be fixedly or removably attached to the exterior shaft, whereas a second end may be fixedly or removably attached to the internal shaft. The first end of the body is further comprised of a handle and grip area, such that a user can comfortably access and retain the device while in use. The second end of the body is comprised of a cap, at least one protrusion, a rounded end, and a space between the protrusions. Preferably two protrusions extend outwards from the cap, bending to form a generally U-shaped curve. The space between the protrusions guides rubber as it is applied to a concrete keyway joint. As the user walks the device along the concrete keyway, rubber is guided into the keyway joint, creating space for the next slab of concrete to be poured.

Accordingly, the rubber applicator device for concrete joint lines of the present invention is particularly advantageous, as it provides a means to apply rubber to a concrete keyway without requiring the user to uncomfortably bend and hunch over. Further, the device allows rubber to be applied to a concrete keyway in an efficient manner. In addition, the length of the device may be increased or decreased to accommodate users of differing heights and to accommodate specific needs of the user. In this manner, the rubber applicator device for concrete joint lines overcomes the limitations of existing methods of applying rubber to concrete keyway joint lines known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the rubber applicator device for concrete joint lines of the present invention in accordance with the disclosed architecture;

FIG. 2 illustrates an enhanced perspective view of one embodiment of the protrusions of the rubber applicator device for concrete joint lines of the present invention in accordance with the disclosed architecture; and

FIG. 3 illustrates a perspective view of one embodiment of the rubber applicator device for concrete joint lines of the present invention in use in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a rubber applicator device for concrete joint lines. There also exists a long-felt need in the art for a device that allows users to remain standing in an upright position, while simultaneously applying rubber to a concrete keyway. Further, there exists a long-felt need in the art for a rubber applicator device that can be extended or retracted in length, to accommodate users of differing heights. In addition, there exists a long-felt need in the art for a rubber applicator device for concrete joint lines that increases the efficiency of applying rubber to a concrete keyway, such that the application is a less time-consuming process.

The present invention, in one exemplary embodiment, is comprised of a rubber applicator device for concrete joint lines that allows a user to remain standing in an upright position while applying rubber to a concrete keyway. The device is primarily comprised of a body, further comprised of an exterior shaft, an interior shaft, a rotating locking mechanism, and at least one protrusion. In differing embodiments, the body may have the appearance of a plurality of differing shapes and sizes as is known in the art depending on the wants and/or needs of a user, and in the preferred embodiment the body is generally slim and cylindrical. The body may also be manufactured of a plurality of suitable materials, such as metal or a flexible or semi-flexible plastic material. In addition, any surface of the body may be comprised of a plurality of indicia, such as patterns, logos, emblems, images, symbols, designs, letters, words, characters, animals, advertisements, brands, etc., or any other suitable indicia as is known in the art.

Further, the body is comprised of two shafts that allow the device to extend in length. An exterior shaft houses an interior shaft of a lesser diameter, such that the interior shaft may extend out of the exterior shaft, increasing the length of the body of the device. The interior shaft may be secured or locked in place, fixing the length of the body of the device by a rotating locking mechanism. The rotating locking mechanism may be positioned on the end of the exterior shaft, from which the interior shaft extends out. However, the rotating locking mechanism may also be positioned at any point along the exterior shaft in differing embodiments. By twisting the rotating locking mechanism, the rotating locking mechanism may compress the exterior shaft into the interior shaft, thus locking the interior shaft in place and temporarily fixing the length of the device. By twisting the rotating locking mechanism in the opposite direction, the device decompresses, allowing the interior shaft to move freely once again.

A first end of the body may be fixedly or removably attached to the exterior shaft. The first end of the body is comprised of a handle and a grip area. The handle of the first end provides a point for a user to retain the device, while using and transporting the device. The handle is further comprised of a grip area. In one potential embodiment, the grip area may have ridges that conform to the human hand or other textual grooves and/or ridges to aid in gripping the device. In another potential embodiment, the grip area may simply be a different material from that of the rest of the handle, or the grip area may be of the same material as the handle but comprised of a plurality of small protrusions that increase surface friction to better retain the device.

A second end of the body may be fixedly or removably attached to the interior shaft. The second end of the body is comprised of a cap, further comprised of a space and at least one protrusion with an end. In the embodiment in which the second end of the body is removably attached to the interior shaft, the cap of the second end and the interior shaft may be comprised of male and female threads, such that the cap is attached by twisting the cap onto the interior shaft. From the cap, preferably two protrusions extend, creating a space between them. The space between the protrusions allows rubber to be guided into a concrete keyway by walking the protrusions along the concrete joint line with the rubber positioned in between the protrusions. The protrusions are each further comprised of an end that is preferably rounded to prevent the protrusions from puncturing the rubber or other material.

Accordingly, the rubber applicator device for concrete joint lines of the present invention is particularly advantageous as it provides a means to apply rubber to a concrete keyway, without requiring the user to uncomfortably bend and hunch over. Further, the length of the device is customizable, such that it can accommodate the needs of users of differing heights and statures. In addition, the device increases the speed and efficiency at which rubber is applied to a concrete keyway joint. Therefore, the device eliminates the need for a user to put unnecessary stress and strain on their back, while applying rubber to a concrete keyway.

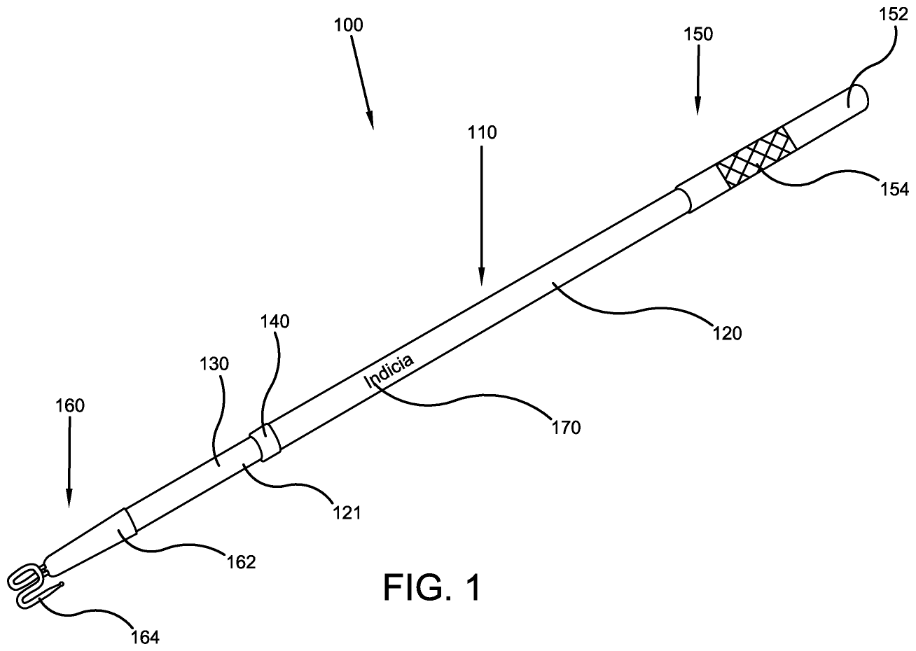

Referring initially to the drawings, FIG. 1 illustrates a perspective view of one embodiment of the rubber applicator device for concrete joint lines 100 of the present invention. The device 100 is primarily comprised of a body 110 further comprised of an exterior shaft 120, an interior shaft 130, a rotating locking mechanism 140, and at least one protrusion 164. In differing embodiments, the body 110 may have the general appearance of a plurality of suitable shapes, such as but not limited to, a cylinder, a rectangular prism, a triangular prism, or any other elongated shape as is known in the art depending on the wants and/or needs of a user. Further, the body 110 may be manufactured of a plurality of suitable materials, such as iron, stainless steel, aluminum, or another lightweight metal, etc., as is known in the art. The body 110 may also be manufactured from a flexible or semi-flexible plastic, such as but not limited to: acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, etc., or any other suitable material as is known in the art. In addition, the body 110 may be transparent, semi-transparent, or opaque in differing embodiments depending on the wants and/or needs of a user. Furthermore, any surface of the body 110 may be comprised of any suitable number of indicia 170 in the form of patterns, logos, emblems, images, symbols, designs, letters, words, characters, animals, advertisements, brands, etc., as is known in the art.

In the preferred embodiment of the device 100, shown in FIGS. 1, 2, and 3, the body 110 is comprised of two shafts, an exterior shaft 120 and an interior shaft 130. Both the exterior shaft 120 and the interior shaft 130 are preferably generally cylindrical in shape but can be any suitable shape as is known in the art based on a user's wants and/or needs. Typically, the exterior shaft 120 comprises a larger diameter than the interior shaft 130, such that the interior shaft 130 fits inside of and may telescope inside of the exterior shaft 120. Thus, the interior shaft 130 may freely extend outwards from the exterior shaft 120, extending the length of the body 110 of the device 100 to accommodate users of differing heights and statures. To lock the interior shaft 130 at a fixed, extended length from the exterior shaft 120, a rotating locking mechanism 140 may be utilized. The rotating locking mechanism 140 comprises a rotating locking collet, spring plunger, threaded connection, etc., or any other suitable locking mechanism as is known in the art. In operation, the rotating locking mechanism 140 is then twisted, compressing the exterior shaft 120 and interior shaft 130 together to secure the interior shaft 130 in the desired position. The rotating locking mechanism 140 may be fixedly attached to any suitable position on the exterior shaft 120, typically, the rotating locking mechanism 140 is positioned on an end 121 of the exterior shaft 120 from which the interior shaft 130 may extend. By twisting the rotating locking mechanism 140 in one direction, the length of the device 100 becomes temporarily fixed by compressing the body 110 of the device 100 and fixating the interior shaft 130. By twisting the rotating locking mechanism 140 in the opposite direction, the rotating locking mechanism 140 decompresses the body 110 of the device 100, allowing the interior shaft 130 to move freely again. However, in one embodiment, the body 110 may only be comprised of an exterior shaft 120 that is comprised of a non-adjustable, fixed length.

Furthermore, a first end 150 of the body 110 is located on the exterior shaft 120. The first end 150 is comprised of a handle 152, further comprised of a grip area 154. The handle 152 is the point from which the user may grip and retain the device 100, while in use or during transportation. The entire handle 152, in one potential embodiment, may be comprised of a material that increases grip and retention of the device 100. In another potential embodiment, the handle 152 may be comprised of a grip area 154 in which a suitable material, such as rubber, etc., aids the user in gripping the device 100. In other potential embodiments, the grip area 154 may be comprised of a plurality of small protrusions, ridges, indentations, etc., to aid in gripping or to better conform to the user's hand.

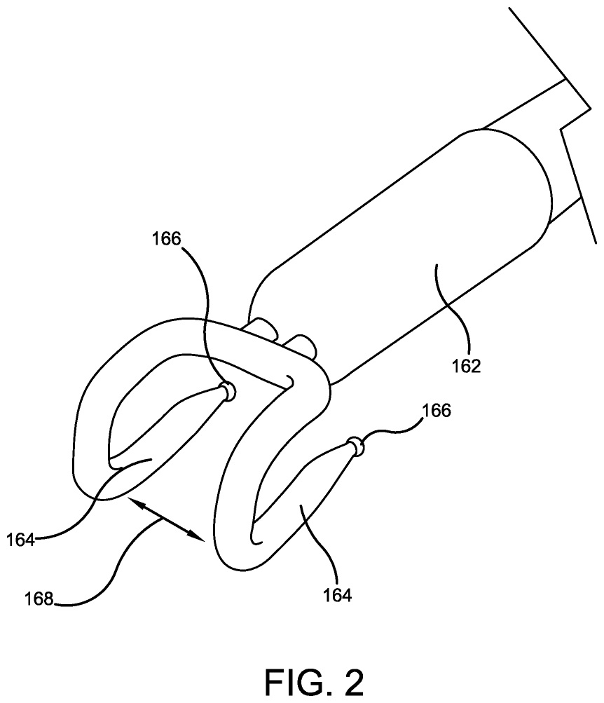

FIG. 2 illustrates an enhanced perspective view of one embodiment of the protrusions 164 of the rubber applicator device for concrete joint lines 100 of the present invention. A second end 160 of the body 110 is located on the interior shaft 130 (shown in FIG. 1). The second end 160 of the body 110 is comprised of a cap 162, further comprised of a space 168 between at least one (but preferably two) protrusion(s) 164 and an end 166 on each protrusion 164. The cap 162 may be fixedly or removably attached around the outside of the end of the interior shaft 130. Preferably, two protrusions 164 extend from the end of the cap 162. In one potential embodiment, the protrusions 164 simply extend outwards. However, in another potential embodiment, the protrusions 164 bend into a generally U-shaped curve and are generally parallel.

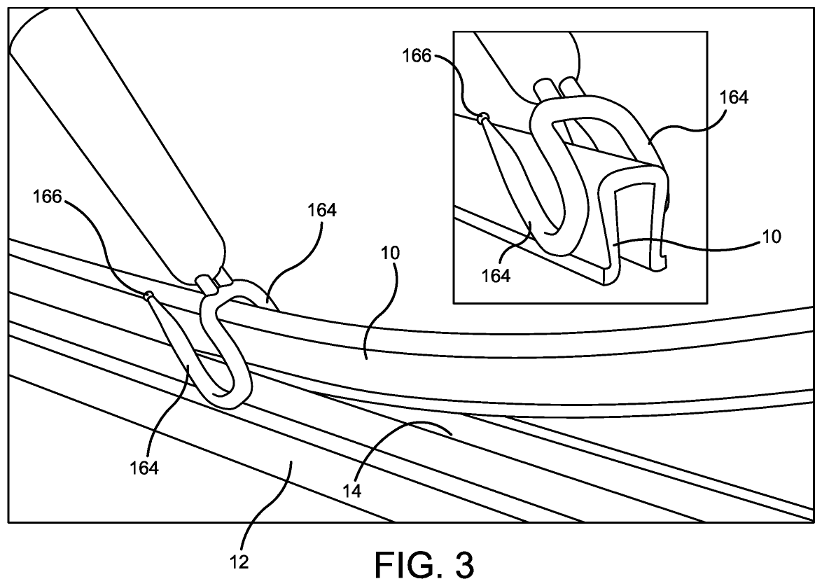

FIG. 3 illustrates a perspective view of one embodiment of the rubber applicator device 100 in use. Specifically, the two protrusions 164 form a space 168 in which rubber 10 may be guided onto a concrete keyway joint 12. As a user walks the device 100 along a concrete keyway joint 12, the space 168 between the protrusions 164 of the cap 162 guides the rubber 10 into the opening 14 of the concrete keyway. As to not damage or pierce the rubber 10 or another suitable material, an end 166 of each protrusion 164 may be smooth, rounded, or generally ball shaped, etc., depending on the wants and/or needs of a user. The round end 166 of each protrusion 164 allows the device 100 to be easily walked along the concrete keyway joint 12, while guiding the rubber 10 into the keyway joint 12.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “rubber applicator device for concrete joint lines” and “device” are interchangeable and refer to the rubber applicator device for concrete joint lines 100 of the present invention.

Notwithstanding the forgoing, the rubber applicator device for concrete joint lines 100 of the present invention and its various components can be of any suitable size and configuration as is known in the art without affecting the overall concept of the invention, provided that they accomplish the above-stated objectives. One of ordinary skill in the art will appreciate that the size, configuration and material of the rubber applicator device for concrete joint lines 100 as shown in FIGS. 1-3 is for illustrative purposes only, and that many other sizes and shapes of the rubber applicator device for concrete joint lines 100 are well within the scope of the present disclosure. Although the dimensions of the rubber applicator device for concrete joint lines 100 are important design parameters for user convenience, the rubber applicator device for concrete joint lines 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A rubber applicator device for concrete joint lines comprising:
a shaft further comprised of:
a first end with a handle; and
a second end with a cap further comprised of a protrusion.

2. The rubber applicator device for concrete joint lines of claim 1, wherein the shaft is adjustable.

3. The rubber applicator device for concrete joint lines of claim 1, wherein the protrusion is curved.

4. The rubber applicator device for concrete joint lines of claim 1, wherein the cap is fixedly attached to the second end.

5. A rubber applicator device for concrete joint lines comprising:
an exterior shaft further comprised of a first end with a handle;
an interior shaft further comprised of a second end with a cap further comprised of a pair of protrusions; and
a locking mechanism.

6. The rubber applicator device for concrete joint lines of claim 5, wherein the interior shaft telescopes within the exterior shaft.

7. The rubber applicator device for concrete joint lines of claim 5, wherein the locking mechanism allows the interior shaft to be locked at a length extended from the exterior shaft.

8. The rubber applicator device for concrete joint lines of claim 7, wherein the locking mechanism is a rotating locking mechanism.

9. A rubber applicator device for concrete joint lines comprising:
an exterior shaft further comprised of a first end with a handle and a grip area; and
a second end with a cap further comprised of a pair of protrusions.

10. The rubber applicator device for concrete joint lines of claim 9, wherein the grip area is manufactured from a rubber material.

11. The rubber applicator device for concrete joint lines of claim 9, wherein the cap is removably attached to the second end.

12. The rubber applicator device for concrete joint lines of claim 9, wherein the pair of protrusions extend away from the cap.

13. The rubber applicator device for concrete joint lines of claim 12, wherein the pair of protrusions are curved.

14. The rubber applicator device for concrete joint lines of claim 13, wherein the pair of protrusions are U-shaped.

15. The rubber applicator device for concrete joint lines of claim 14, wherein the pair of protrusions forms a space between the pair of protrusions.

16. The rubber applicator device for concrete joint lines of claim 15, wherein the pair of protrusions are generally parallel.

17. The rubber applicator device for concrete joint lines of claim 16, wherein an end of each of the pair of protrusions is rounded.

18. The rubber applicator device for concrete joint lines of claim 16, wherein an end of each of the pair of protrusions has a ball.

19. The rubber applicator device for concrete joint lines of claim 18, wherein each of the pair of protrusions is smooth.

20. The rubber applicator device for concrete joint lines of claim 9, wherein the exterior shaft is manufactured from metal.
